(19) United States
(12) Patent Application Publication
(10) Pub. No.: US 2012/0273429 A1
(43) Pub. Date: Nov. 1, 2012

(54) METHOD FOR SEPARATING GRINDING OIL FROM GRINDING SLURRY; SEPARATING STATION FOR CARRYING OUT SAID METHOD AND PLANT ACCORDING TO SAID METHOD

(76) Inventor: Erwin Junker, Buehl/Baden (DE)

(21) Appl. No.: 13/511,110

(22) PCT Filed: Oct. 21, 2010
(86) PCT No.: PCT/EP2010/065887

§ 371 Date: Jun. 28, 2012

(30) Foreign Application Priority Data
Nov. 20, 2009 (DE) 10 2009 054 076.8

(51) Int. Cl. B01D 35/18; B01D 21/00; B01D 21/26

(52) U.S. Cl. 210/695; 210/774; 210/175; 210/187; 210/182; 210/179

(57) ABSTRACT

The invention relates to a plant for separating grinding slurry originating from grinding machines into metal chips and grinding oil. According to the invention, a carrier bowl (3) in a frame (1) is filled with a divided volume of the grinding slurry (10). The carrier bowl (3) has a perforated plate (4) having an edge (5) as a floor and a sieve-like intermediate floor (8). By means of a lifting device (2), the carrier bowl (3) is moved to the effective region of an inductor plate (9) serving as a heater. The induction heat heats the ferromagnetic steel or iron particles present in the grinding slurry (10). Said heating effects a reduction in viscosity of the grinding oil in the grinding slurry (10), from which substantial portions flow downward through the openings (6) or (7). In certain cases, the effect can be improved by placing a steel plate on the free surface (16) of the grinding slurry layer (10).

### BACKGROUND OF THE INVENTION

The invention relates to a method for separating grinding oil from grinding slurries and to separating stations for carrying out the method. A method and a separating station of this type are known from DE 196 00 505 A1.

The known method is already designed for creating the preconditions for disposal or reuse of the individual grinding slurry components. Reducing the content of grinding oil in the grinding slurry to a sufficient extent allows the metal component to be reused in a steelworks or in a foundry, or the grinding oil may be separated with such a degree of purity that it can be reconditioned and reused. The known method pursued the aim of reducing the costs of the separating or purifying method, with low expenditure on equipment and process control. As provided by the proposal of DE 196 00 505 A1, for this purpose a method of mechanical separation is combined with a thermal process. To be specific, according to DE 196 00 505 A1, the mechanical separation is performed in a centrifuge and the grinding slurry is at the same time heated, in that electrical eddy currents are generated by magnetic induction in the finely divided metallic phase. The required magnetic field may be generated by permanent magnets or electromagnets, which are arranged in a stationary manner in the rotating drum of the centrifuge.

The known method has the disadvantage that the components of the grinding oil that are freed from the grinding slurry rise in the drum from the bottom upward and, as they do so, to some extent have to pass through the slurry cake that is deposited on the inner wall of the drum and becomes increasingly thick in the downward direction as a result of gravitational force. Furthermore, in the case of such a centrifuge, the slurry cake has to be scraped off the inner wall of the centrifuge at regular intervals, which entails considerable work. With the known method, continuous operation is only likely to be possible by providing two centrifuges, which are alternately operated and serviced.

### SUMMARY OF THE INVENTION

Against this background, the invention is based on the object of providing a method of the type mentioned at the beginning in which there are clear physical conditions both for introducing the heat into the grinding slurry and for removing those grinding oil components of which the kinematic viscosity is sufficiently reduced, so that reliable continuous operation is possible with great effectiveness and good utilization of the energy that is used.

The advantageous effects of the method according to the invention come about firstly by the grinding slurry being spread out on a carrier into a flat layer of low height. exposing the free surface of the flat layer of grinding slurry to the effective range of an inductor plate acting from above provides clear geometrical conditions for the heating up of the layer. Since the heating takes place from above, the grinding oil that is reduced in its viscosity can leave the grinding slurry in a downward direction, because suitable openings are provided in the carrier. The grinding slurry heated up still further is consequently freed immediately of the grinding oil components that have become mobile and is well able to undergo further heating. The removal of the grinding slurry reduced in its grinding oil content takes place outside the effective range of the inductor plate, whereas the application of the layer of grinding slurry to the carrier may take place either in or outside its effective range. This arrangement ensures good utilization of the heat generated by the inductor plate, which is produced directly in the metal components of the grinding slurry. The spreading out and heating of a pizza dough may serve as a graphic analogy for the approach according to the invention. If the grinding slurry is to be applied to the carrier in the effective range of the inductor plate, this may take place for example from the side obliquely downward onto the carrier, into the intermediate space between the inductor plate and the carrier.

Particularly good experiences have been had with a layer of grinding slurry 2 to 30 mm thick on the carrier. However, this size range is in any case not obligatory; depending on the characteristics of the grinding slurry and the degree of kinematic viscosity of the grinding oil, advantageous results can also be achieved with greater layer thicknesses.

The inductive heating of the grinding slurry is of course dependent on how pronounced the ferromagnetic properties of the metal chips and/or the metal dust in the grinding slurry are. The increase in temperature may take place to differing degrees, by the induction heating being switched on with differing degrees of intensity and duration. When there are weaker ferromagnetic properties, it is expedient to place onto the free surface of the flat layer of grinding slurry a steel plate, which is located in the effective range of the inductor plate between the latter and the free surface of the layer of grinding slurry. In this case, the inductor plate especially heats up the steel plate, which then gives off its heat to the layer of grinding slurry lying thereunder.

In particular if the grinding slurry is still contaminated by further substances, it may also be expedient to place in the flat layer of grinding slurry a further steel plate, which is then located at a distance above the carrier, that is to say is arranged within the layer of grinding slurry. This additional plate may be formed as a perforated plate or as a screen and is likewise inductively heated by the inductor plate. This heat source located within the layer of grinding slurry allows the disadvantages of weaker ferromagnetic properties or of contamination of the grinding slurry to be balanced out.

In a first refinement, the method according to the invention may be performed by divided portions of the grinding slurry being spread out on a carrier bowl, which is then brought into the effective range of the inductor plate from below. This leads to a comparatively simple plant that is suitable for separating not excessively great amounts of the grinding slurry.

Another procedure involves forming the carrier as an endless conveyor on which there are formed at least three carrier bowls, which are fed one after the other to the operations of a) spreading, b) inductively heating by the inductor plate and c) unloading. The movement of the endless conveyor in this case takes place cyclically, and for the heating operation the inductor plate is respectively lowered from above onto the carrier bowl concerned. The endless conveyor may in this case be formed as a belt conveyor with a linear conveying direction or else as a circular conveyor. Further advantageous refinements are specified in dependent claims relating to the individual methods.

In addition, however, a completely continuous procedure is also possible, in that the method is carried out with a continuously moved belt conveyor, the upper strand of which serves as a carrier for a continuously deposited layer of grinding slurry and takes it through below a constantly activated inductor plate. In this case, the running speed of the upper strand controls the introduction of heat into the layer of grinding slurry, with in addition to this the possibilities of influencing the inductor plate.

The methods according to the invention that are presented here can be combined well with pretreatment stages, which may comprise mechanical separation of the grinding oil from the grinding slurry and a subsequent preheating of the grinding slurry. In this way it is achieved that the electrical energy of the inductor plate is only introduced and utilized in the last treatment stage, in a particularly cost-effective way.

With the method according to the invention that is presented here it is possible to separate considerably more grinding oil from the grinding slurry and pass it on for reuse. The grinding oil especially represents a not inconsiderable cost factor in abrasive working. The higher the proportion of grinding oil that can be recovered, the more cost-effective the grinding method as a whole. With the method according to the invention that is described above, it is now possible to separate so much grinding oil from the grinding slurry that only small residual amounts remain in the grinding slurry. But even these small residual amounts may have the effect that the grinding slurry is regarded as hazardous waste and is not necessarily suitable for being reused, for example by melting the abrasively removed metal. According to a further refinement of the invention, it is therefore provided that, after the separation of grinding oil by reducing its viscosity, in a downstream method step the residual amount of grinding oil is burned. This may be achieved, for example, by the device for the inductive heating of the grinding oil being controlled such that its temperature is raised into the range of the combustion temperature and it is burned. However, it is also possible that an additional energy source is provided, by means of which the remaining grinding oil is burned. Such an additional energy source may, for example, also be a burner.

The invention also relates to separating stations, with which the method according to the invention can be carried out in its distinct individual forms. The individual separating stations are described hereinafter and shown in the drawings. It should be emphasized here in particular that the base of the carrier bowl, which is formed as a flat plate, may if need be also consist of a ferromagnetic material. This again applies to the case where the ferromagnetic properties of the metal component in the grinding slurry are insufficient or where the grinding slurry is contaminated. In this case, the inductor plate acts up to the base of the carrier bowl and generates from there a thermal effect. This is based again on the layer thickness of the grinding slurry spread out in the carrier bowls being relatively thin.

Finally, the invention also relates to a processing plant in which grinding oil is separated from grinding slurries, in that a mechanically acting separating device is combined with an inductive heating means. The particular feature of this plant is that the individual procedures are separate and are carried out in different treatment stations. After a mechanically acting separating device and a preheating, inductive separation with a separating station according to the invention may be performed as the third and preferably last treatment. This can therefore be optimized particularly well. A fourth treatment station is preferably provided, comprising a separating station with an additional energy source or with a controllable inductive device for burning residual amounts of grinding oil.

The invention is explained in more detail below on the basis of exemplary embodiments, which are represented in drawings. The figures show the following:

### BRIEF DESCRIPTION OF THE DRAWINGS

FIG. 1 explains in a longitudinal section the principle of a separating station according to the invention in a first embodiment.

FIG. 2 shows an additional detail of the separating station according to FIG. 1.

FIG. 3 shows the representation of a multistage processing plant in which a separating station according to FIG. 1 forms the final stage.

FIG. 4 explains a second embodiment of a separating station according to the invention.

FIG. 5 shows the representation of a separating station according to FIG. 4, in which a further treatment unit is added.

FIG. 6 shows the principle of a third embodiment in a view of the separating station from above.

FIG. 7 shows the partially sectioned side view associated with FIG. 6.

FIG. 8 explains the principle of a fourth embodiment.

### DETAILED DESCRIPTION OF THE INVENTION

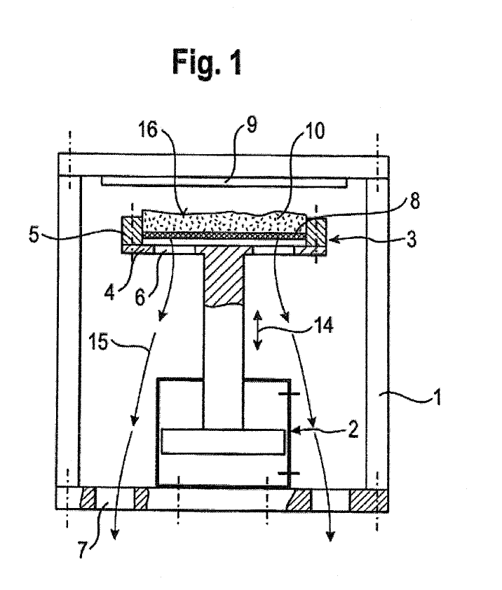

In FIG. 1, a separating station according to a first embodiment is represented. Arranged here in a frame 1 is a lifting device 2, which is indicated in the form of an adjusting piston with a solid piston rod that is suitable as a supporting column. The lifting device serves the purpose of moving a carrier bowl 3 upward and downward, cf. the directional arrow 14 for the lifting movement. The carrier bowl comprises a flat plate 4 with a rising-up rim 5, surrounding the flat plate 4, and has a circular cross section. The flat plate 14 is provided with openings 6, through which separated grinding oil can flow off, cf. the directional arrow 15 for the flow-off direction. The base of the frame 1 is also provided with openings 7 for the same purpose.

Arranged at a distance above the flat plate 4 of the carrier bowl 3 is a permeable intermediate base 8. It may be formed as a screen base or in the form of a perforated plate. The through-flow openings of the intermediate base 8 are small in relation to the openings 6 in the flat plate 4. The permeable intermediate base 8 makes it possible for grinding oil components with reduced viscosity to flow or drip off unhindered from the layer of grinding slurry 10. The mesh width of the screen or the hole diameter of a perforated plate depends on the characteristics of the grinding slurry and the kinematic viscosity of the grinding oil.

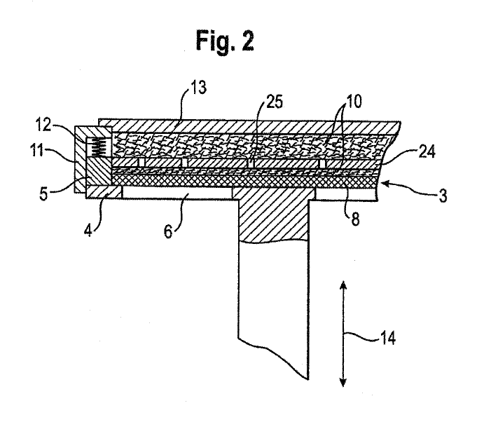

FIG. 2 shows further details with which the function of the carrier bowl 3 can be improved. An abutting frame 11 may be placed onto the carrier bowl 3, surrounding the rim 5 of the carrier bowl 3 in a slidable manner and being supported in an elastically yielding manner on the carrier bowl 3. The elastic yieldingness may be brought about by a series of helical springs 13, which are located between the rim 5 of the carrier bowl 3 and the abutting frame 11. The abutting frame 11 has for this purpose an inwardly angled profile.

The abutting frame 11 is intended for interacting with an inductor plate 9, which is located above the carrier bowl 3 and covers with its surface area the surface area of the carrier bowl 3. The carrier bowl 3 and the inductor plate 9 are arranged extending parallel to one another. During the operation of the separating station, there is on the carrier bowl 3 a layer of grinding slurry 10, which contains grinding oil. The carrier bowl 3 is moved by means of the lifting device 3 up close to the inductor plate 9, until the layer of grinding slurry 10 is in the effective range of the inductor plate 9. At the same time, however, the free surface 16 of the layer of grinding slurry 10 must not come into contact with the inductor plate 9, since induction heating is produced in any case without direct contact. When the carrier bowl 3 is brought up to the inductor plate 9, the abutting frame 11 with sliding properties has the effect that the layer of grinding slurry 10 located on the carrier plate 3 is held together, so that none of the grinding slurry 10 can fall down.

The carrier bowl 3 and the inductor plate 9 covering it may be of a circular or square form or of some other form, for example rectangular. The induction heating principle is not affected by this.

In the case of a grinding slurry of ferromagnetic materials, the inductor plate 9 has the effect that the heat is produced directly in the steel or iron parts of the grinding slurry. If, however, the ferromagnetic properties of the material are only weak or are absent, the steel plate 13 that can be seen in FIG. 2 is placed onto the free surface 16 of the layer of grinding slurry 10. The inductively generated heat is then produced in the steel plate 13 and is given off to the layer of grinding slurry 10 lying thereunder. Since the carrier bowl 3 and the abutting frame 11 themselves are not to be heated up, they should generally not consist of ferromagnetic materials, but for example of heat-resistant plastics. A placed-on ferromagnetic steel plate can in any event contribute to the heating of the divided layer of grinding slurry 10.

If, however, the grinding slurry does not just consist of metal chips and grinding oil, but is contaminated quite a lot by other components, for example filtering aids and additives, the heating of the grinding slurry by the inductor plate may be greatly reduced in spite of ferromagnetic grinding chips. In these cases, it is advantageous if a further steel plate 24, which is perforated or formed as a screen, is also placed in the spread-out flat layer of grinding slurry 10 in the layer of grinding slurry. This additional plate 24 with the through-openings 25 is then located within the layer of grinding slurry 10. The plate 24 is consequently arranged above the flat plate 4, which forms the base of the carrier bowl 3, or above the permeable intermediate base 8. The induction heating in this case has the effect of strongly heating the additional steel plate 24, and this heat is transferred to the layer of grinding slurry 10, in which the additional plate 24 is embedded.

Such a desired additional heating effect may in certain cases also have the effect that the flat plate 4 of the carrier bowl 3 is advantageously formed at least partially from a ferromagnetic material.

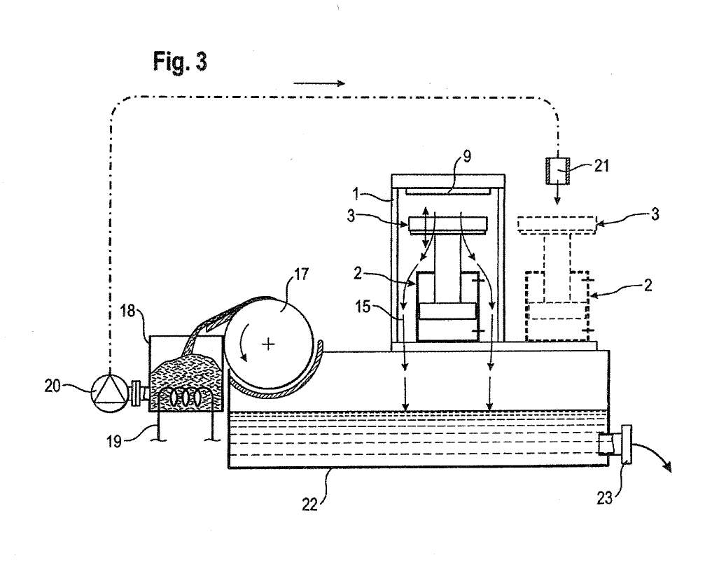

FIG. 3 reveals how the separating station according to the first exemplary embodiment described thus far can be inserted into a processing plant for separating the grinding oil from grinding slurry. The plant represented comprises three treatment stations, of which the first is formed by a magnetic roller 17. It serves the purpose of removing relatively large metal parts from the grinding slurry, and consequently relieving the downstream separating operations.

From the magnetic roller 17, the grinding slurry passes into the second treatment station, which is formed by a tank 18. The tank is heated by means of a heat exchanger 19, which is indicated as a heating coil. The heating of the heating fluid may take place in a special unit (not represented here) by the waste heat of peripheral units that are present at the cooling-lubricant reconditioning plant and the grinding machine. This preheating has the effect that the grinding oil of the grinding slurry is already reduced in its viscosity, so that the grinding slurry can be conveyed better. With a feed pump 20, the grinding slurry is then fed to the third treatment station, which comprises the separating station according to FIGS. 1 and 2 and begins at the feeding station 21.

The plant described thus far and the associated separating station operate as follows: after passing through the magnetic roller 17 and the heated tank 18, the preheated grinding slurry is fed by the feed pump 20 to the feeding station 21. Here it is important to spread out the grinding slurry in a thin layer on the carrier bowl 3. The measures for this are not represented in the figures. The analogy of spreading out a pizza dough may serve as a graphic example. A layer thickness of 2 to 30 mm has proven to be particularly advantageous. However, in many cases, a layer thickness differing from this may likewise lead to usable results; depending on the application, the characteristics of the grinding slurry and the kinematic viscosity of the grinding oil contained therein lead to different procedures. Excessively thick layers have the effect that it takes too long for the amount of grinding slurry 10 located on the carrier bowl 3 to heat up and for the grinding oil components of which the viscosity is reduced to be discharged from the grinding slurry 10.

As can be seen in FIG. 3, the carrier bowl 3 at the feeding station 21 is in its lowered position and has been moved laterally out of the machine frame 1 together with the lifting device 2 (representation in dashed lines). After the spreading out of the grinding slurry into a thin layer 10, located on the carrier bowl 3, the lifting device 2 is moved back again and under the inductor plate 9. The lifting device 2 then comes into action and moves the carrier bowl 3 with the divided layer of grinding slurry 10 located on it upward into the effective range of the inductor plate 9. The separating station is formed in such a way that the inductor plate 9 is only electromagnetically activated when the respective divided layer of grinding slurry 10 has reached the effective range of the inductor plate 9. The operation may be controlled automatically, so that the induction heating is switched on or off of its own accord when the divided layer of grinding slurry 10 reaches or leaves the effective range of the inductor plate 9.

The layer of grinding slurry 10 is then heated up. The increase in temperature may take place to differing degrees, by the induction heating being switched on with differing intensity and duration. The process may be automatically controlled, and in this way serve for saving energy. The influence of the temperature on the viscosity of the grinding oil is considerable. For example, a typical grinding oil at a temperature of 40° C. has a kinematic viscosity of 10 cst and at about 95° C. only of 3 cst. At the same time, commercially available grinding oils can be heated up to 80 to 120° C. without their decisive properties changing or additives being destroyed.

On account of its reduced viscosity, components of the grinding oil can leave the layer of grinding slurry 10 located on the carrier bowl 3 and pass via the permeable intermediate base 8 and the openings 6 in the flat plate 4 of the carrier bowl 3 downward onto the base of the machine frame 1. This base for its part again has openings 7 (cf. FIG. 1), which provide access to a grinding oil collecting tank 22 lying thereunder. In this way, the components of the grinding oil that are separated in the layer of grinding slurry 10 pass in the form of drips or trickles finally into the grinding oil collecting tank 22. After collecting a sufficient amount, the grinding oil can be passed on for reuse or reconditioning via the emptying nozzle 23.

With careful process control, a residual oil content of 5 percent and less can be achieved in the way described. Lastly, the largely dried layer of grinding slurry 10 must be removed from the carrier bowl 3. As provided by the exemplary embodiment according to FIG. 3, for this purpose the carrier bowl 3 is removed from the inductor plate 9 by the lifting device 2, that is to say is lowered in the downward direction. For unloading the carrier bowl 3, the lifting device 2 is moved out again laterally from the frame 1. The carrier bowl 3 can then be unloaded underneath the feeding station 21 or at some other location. However, this procedure is not obligatory; the loading and unloading may also be performed within the frame 1, if sufficient space is available underneath the inductor plate 9.

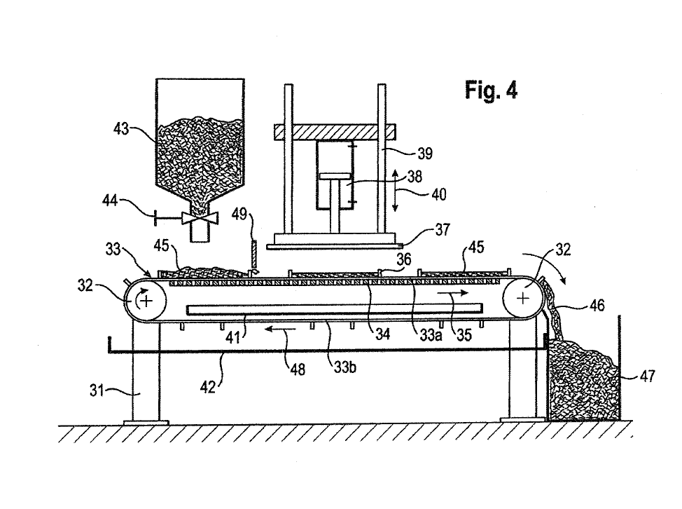

A second exemplary embodiment of a separating station according to the invention is represented in FIG. 4. This provides that two rollers 32 are rotatably mounted on a machine frame 31, at least one of which rollers is motor-driven. An endless conveyor 33 runs over the rollers 32 on the belt conveyor principle. The endless conveyor 33 may be formed as a filter belt, fabric belt or link belt that is permeable to grinding oil. The upper strand 33a of the endless conveyor 33 is supported almost over its entire length on a perforated plate 34, so that it cannot sag. The length of the upper strand 33a determines the length of a conveying section; the conveying direction 35 runs from left to right in FIG. 4. Formed at regular intervals on the outer side of the endless conveyor 33 are carrier bowls 36, the rising-up rims of which can be seen in FIG. 4. Since the bases of these carrier bowls 36 must in any case be permeable, they can be formed well by links of a link belt, but also by the filter belt or fabric belt itself that primarily comes into consideration for the endless conveyor 33.

Over the longitudinal center of the endless conveyor 33 there is the inductor plate 37. Its distance in height from the carrier bowls 36 can be varied by means of a lifting device 38. The lifting device 38 is again indicated as a piston-cylinder unit. The inductor plate 37 is in this case guided on guiding rods 39, and the direction of the lifting movement is indicated by the double-headed arrow 40.

Fitted in the interior space between the two strands 33a, 33b of the endless conveyor 33 is a collecting trough 41, which extends almost over the entire conveying length of the endless conveyor 33 and consequently can receive all the drips or trickles of the grinding oil that leave the grinding slurry 45 located on the endless conveyor 33. The run-off for the grinding oil located in the collecting trough 41 is provided laterally, that is to say perpendicularly in relation to the plane of the drawing.

Provided underneath the subassembly comprising the entire longitudinal conveyor 33, the rollers 32 and the collecting trough 41 is a catching trough 42. This serves the purpose of receiving remains of grinding slurry and grinding oil that fall from the lower strand 33b of the longitudinal conveyor 33 when it is running back empty in the running direction 48 and the emptied carrier bowls 36 are directed downward.

Arranged upstream of the lifting device 38 with respect to the conveying direction 35 of the endless conveyor 33 is an inlet slurry tank 43. Located in this tank is the preheated grinding slurry with a still high content of grinding oil. A divided portion of grinding slurry 45 is taken from the inlet slurry tank 43 via an automatically actuated metering valve 44 when an empty carrier bowl 36 is located under said tank. Again, application in a thin layer should be accomplished; as has been made clear by the analogy with the pizza dough. A fixed doctor blade 49 serves the purpose of eliminating major irregularities in the layer thickness of the layer of grinding slurry 45. The doctor blade 49 comes into effect when the carrier bowl 36 passes by it.

Provided downstream of the lifting device 38 in the conveying direction 35 is the emptying station of a very simple configuration. Since the way in which they are formed on the flexible endless conveyor 33 means that the carrier bowls 36 are likewise flexible, it is sufficient to pass them over the roller 32 present at the end of the conveying section, the carrier bowls 36 opening and turning upside down, so that a slurry discharge occurs at the location 46. The grinding slurry 45 reduced in its grinding oil content falls into an outlet slurry tank 47.

To operate the separating station according to FIG. 4, the endless conveyor 33 is moved cyclically, that is to say intermittently. When an empty carrier bowl 36 arrives under the inlet slurry tank 43, a divided portion 45 of the grinding slurry is automatically spread out in this carrier bowl 36 into a thin layer by means of the metering valve 44. In the subsequent cycle movement of the endless conveyor 33, this divided layer of grinding slurry 45 arrives under the inductor plate 37. By means of the lifting device 38, at the same time the inductor plate 37 is moved downward, until the divided layer of grinding slurry 45 is in the effective range of the induction heating. The induction heating then switches on automatically, i.e. the inductor plate 37 is electromagnetically activated. The same details that have already been presented with respect to the first exemplary embodiment apply to the heating operation.

Those components of the grinding oil of which the viscosity has been reduced sufficiently by being heated up are then freed from the layer of grinding slurry 45 and make their way down in the form of trickles or drips through the upper strand 33a of the endless conveyor 33 and the perforated plate 34 into the collecting trough 41. With the next working cycle, the induction heating is switched off, and the residual slurry is discharged from the endless conveyor 33 at the location 46 and passes into the outlet slurry tank 47.

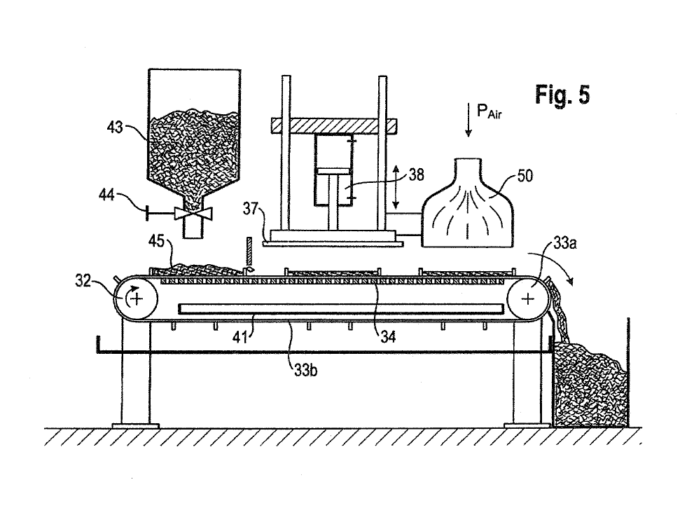

The exemplary embodiment as provided by FIG. 5 largely corresponds to that according to FIG. 4. Therefore, the most important details of the separating station according to FIG. 5 are designated by the same reference numerals as in FIG. 4. A difference in FIG. 5 is the arrangement of a blasting head 50, which is fixedly connected to the lifting device 38 of the inductor plate 37. The lateral distance from the inductor plate 37 is in this case fixed such that the following effect comes about: when the inductor plate 37 is located exactly over a carrier bowl 36 and covers it, the blasting head 50 is located exactly over the adjacent carrier bowl 36 that is further forward in the conveying direction 35 of the endless conveyor 33. While the inductor plate 37 is heating up the divided layer of grinding slurry 45 located thereunder, a stream of air is directed by the blasting head 50 onto the layer of grinding slurry 45 located alongside it, which has already been heated up. Drips of grinding oil that already have a reduced viscosity but have not yet been freed from the layer of grinding slurry 45 are thereby likewise driven out from the layer of grinding slurry 45. In order that these drips of grinding oil can also be caught, the collecting trough 41 in the configuration according to FIG. 5 has been extended up to the roller 32, which is located at the end of the conveying section.

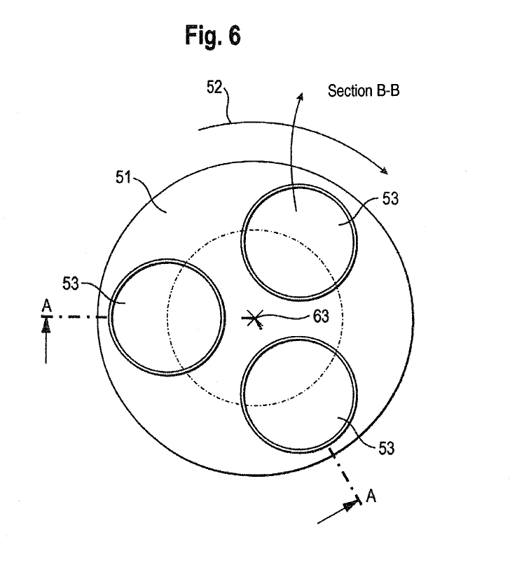

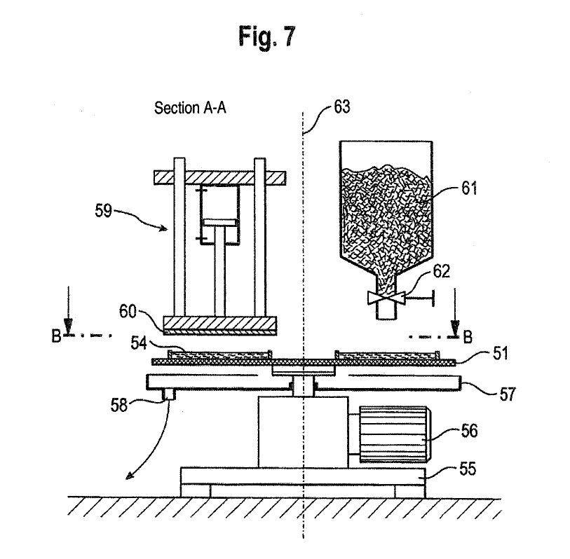

In the case of the third embodiment according to FIGS. 6 and 7, the endless conveyor is formed as a circular conveyor 51. In FIG. 6, which corresponds to a section B-B through FIG. 7, the principle is only shown schematically. The circular conveyor 51 has the form of a flat circular disk that is rotatable about its center axis 63, that is to say forms a carousel. The direction of rotation of the circular conveyor 51 is identified by the directional arrow 52. On the circular conveyor 51 there are three circular carrier bowls 53 for receiving and treating divided layers of grinding slurry 54, cf. FIG. 7. The way in which they operate is the same in principle as in the case of the separating station already described, with the belt conveyor which is moved cyclically in a linear direction. Each of the three carrier bowls 53 passes one after the other through the treatment units of a) loading and spreading, b) inductively heating and c) unloading.

FIG. 7, which corresponds to a section along the line A-A in FIG. 6, shows further details. Mounted on a frame 55 is a drive unit 56, which sets the circular conveyor 51 in rotation in a cyclical manner. The circular conveyor 51 is permeable in the region of the carrier bowls 53, for example by means of a fabric pad. Underneath the circular conveyor 51 there is a fixed drip trough 57 with the run-off opening 58 for the grinding oil that has left the divided layer of slurry 54. Shown above the circular conveyor 51 are a lifting device 59 with an inductor plate 60 and also an inlet slurry tank 61 with a metering valve 62.

The configurations as provided by FIGS. 4 to 6 show endless conveyors 33 or circular conveyors 51 with in each case three carrier bowls 36 and 53, respectively. However, this number is in no way obligatory. The arrangement of the blasting head 50 according to FIG. 5 may alone mean that, as a further treatment station, it also requires a further carrier bowl 36. Similarly, it may be expedient to arrange upstream of the station with the inductor plate 37 or 60, in the conveying direction 35 of the separating station as provided by FIG. 4 or in the direction of rotation 52 of the circular conveyor 51 as provided by FIG. 6, a heating-up station, so that the divided layers of grinding slurry 45 or 54 are once again separately heated up before reaching the inductor plate 37 or 60, respectively. In such cases, a further carrier bowl 36 or 53, respectively, would also have to be accommodated on the conveying devices. General production-related technical reasons could also necessitate a greater number of carrier bowls.

In the separating stations with endless conveyors described thus far, cyclical, that is to say discontinuous, operation of the conveying devices has been assumed. In these cases, the dwell time of the carrier bowls 36, 53 under the inductor plate 37, 60 has an influence on the amount of heat that is introduced into the layer of grinding slurry 45, 54.

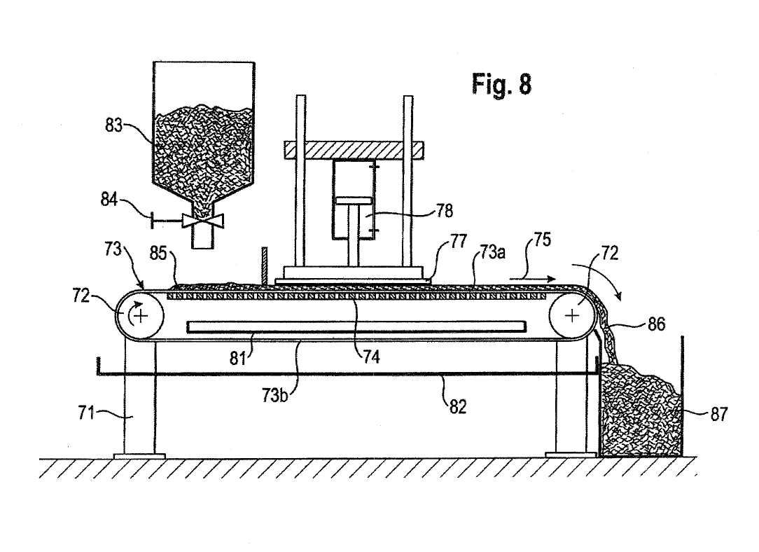

However, the method according to the invention may also be carried out in continuous operation. An example of this is shown in FIG. 8. Mounted here on a frame 71 are two rollers 72, over which a belt conveyor 73 runs in the manner of a conveyor belt. The belt conveyor has an upper strand 73a and a lower strand 73b and is again formed as a filter belt, fabric belt or link belt that is permeable to grinding oil. The upper strand 73a is supported on a perforated plate 74 and moves in the conveying direction 75. It thereby runs through in continuous operation under the stationarily arranged inductor plate 77. A lifting device 78 serves in the case of FIG. 8 only for the one-off setting of the correct distance respectively from the upper strand 73a or for the carrying out of servicing work. When operation is in progress, however, the inductor plate is spatially fixed and constantly activated. The remaining structural formation corresponds to the representation according to FIGS. 4 and 5. Here, too, the layer of grinding slurry 85 is applied from an inlet sludge tank 83 via a metering valve 84 to the upper strand 73a of the belt conveyor 73. At the location 86, the discharge of the grinding slurry 85 from the upper strand into an outlet sludge tank 87 takes place. The components of the grinding oil that are freed from the layer of grinding slurry 85 pass through the belt conveyor 73 and the perforated plate 74 into the collecting trough 81. In the catching trough 82, remains of the grinding slurry that still stick to the lower strand 73b of the belt conveyor 73 during the discharge can be caught.

The main difference is that the grinding slurry located in the inlet sludge tank 83 is continuously deposited via the metering valve 84 on the likewise continuously moving belt conveyor 73. In this way, an endless and continuously moved layer of the grinding slurry is produced, running through under the inductor plate 77. Apart from the controllable power output of the inductor plate, decisive here for the amount of heat that is introduced into the layer of grinding slurry 85 is the speed at which the upper strand 73a of the belt conveyor 73 runs through under the inductor plate.

1. A method for separating grinding oil from a grinding slurry comprising:
a) spreading out the grinding slurry on a carrier into a flat layer;
b) inductively heating the flat layer of grinding slurry by exposing a free surface of the flat layer of grinding slurry to an effective range of an inductor plate acting from above, while moving the inductor plate and the carrier in relation to one another;
c) downwardly drawing off the grinding oil reduced in its viscosity by the inductive heating, through openings in the carrier; and
d) removing the layer of grinding slurry from the carrier outside the effective range of the inductor plate.

2. The method as claimed in claim 1, wherein the flat layer of grinding slurry is applied to the carrier with a thickness of 2 to 30 mm.

3. The method as claimed in claim 1, wherein the layer of grinding slurry is applied to the carrier outside the effective range of the inductor plate.

4. The method as claimed in claim 1, further comprising placing a steel plate onto the free surface of the flat layer of grinding slurry and in the effective range of the inductor plate, between the inductor plate and the free surface of the layer of grinding slurry.

5. The method as claimed in claim 4, wherein the steel plate is perforated or formed as a screen and is placed in the flat layer of grinding slurry above and spaced from the carrier.

6. The method as claimed in claim 1, wherein the carrier comprises a carrier bowl parallel to the inductor plate and the movement the inductor plate and the carrier bowl in relation to one another is effected so that one after the other reach one of the following positions:
a) a loading position, in which the carrier bowl and the inductor plate are removed from one another and the grinding slurry is spread out on the carrier bowl;
b) an inductive heating position, in which the carrier bowl is close to the inductor plate and the layer of grinding slurry is located in the effective range of the inductor plate;
c) an unloading position, in which the carrier bowl and the inductor plate are removed from one another and the layer of grinding slurry, the content of grinding oil of which has now been reduced, is transferred to a collecting or transporting device.

7. The method as claimed in claim 6, wherein the inductor plate is stationarily horizontally mounted and the carrier bowl is brought into the effective range of the inductor plate by being moved upwardly from a lowered position, and the loading and unloading of the carrier bowl takes place in the lowered position of the carrier bowl.

8. The method as claimed in claim 7, wherein, in its lowered position, the carrier bowl (3) is moved horizontally into its loading or unloading position.

9. The method as claimed in claim 6, wherein at least three carrier bowls, among which the grinding slurry is apportioned, are arranged on an endless conveyor are formed, the conveyor is moved cyclically in a horizontal direction underneath the inductor plate, and the operations of a) spreading, b) inductively heating and c) unloading are thereby carried out one after the other on portions of the grinding slurry.

10. The method as claimed in claim 9, wherein the conveyor is held at a fixed height and the inductor plate is moved upwardly and downwardly.

11. The method as claimed in claim 10, wherein the horizontal movement is effected by a belt conveyor with a conveying direction in a straight line or by a circular conveyor.

12. The method as claimed in claim 9, further comprising, between the operations of inductively heating and unloading, treating the layer of grinding slurry on the carrier bowl with a stream of air, which drives or draws out further grinding oil from the layer of grinding slurry.

13. The method as claimed in claim 6, comprising electromagnetically activating the inductor plate only whenever the layer of grinding slurry has completely reached the effective range of the inductor plate.

14. The method as claimed in claim 1, wherein the method it is carried out with a continuously running belt conveyor, an upper run of which serves as a carrier for a continuously deposited layer of grinding slurry and carries said layer underneath and past a constantly activated inductor plate, and, based on running speed of the upper run, controlling introduction of heat into the layer of grinding slurry.

15. The method as claimed in claim 1, further comprising a first pretreatment comprising mechanical separation of grinding oil from the grinding slurry and then a second pretreatment comprising preheating the grinding slurry.

16. The method as claimed in claim 15, wherein the mechanical separation is effected by at least one of magnets, centrifuging or sedimentation and the heat for preheating the grinding slurry is from re-cooling of cooling lubricant required for grinding and/or from lost heat of peripheral units of grinding machines.

17. The method as claimed in claim 1, wherein the grinding slurry is heated to the extent that residual amounts of the grinding oil are burned.

18. A separating station for separating grinding oil from a grinding slurry, comprising a carrier bowl arranged on a lifting device for receiving a flat layer of grinding slurry and being provided with openings for draining away heated grinding oil, and an inductor plate arranged above the carrier bowl for inductively heating the layer of grinding slurry, the lifting device having an upper position for heating the flat layer of grinding slurry in the bowl and a lower position for loading the slurry into and unloading the slurry from the bowl.

19. A separating station for separating grinding oil from a grinding slurry, comprising:
a) an endless conveyor movable cyclically in a horizontal plane and at least three carrier bowls arranged on the conveyor each for receiving a respective layer of grinding slurry;
b) treatment units, mounted over the conveyor, for filling, inductively heating and removing the layers of grinding slurry from the carrier bowls;
c) the treatment unit for heating comprising a lifting device with an inductor plate located on it, the lifting device being movable between a raised position ineffective for inductive heating by the inductor plate of a layer of slurry arranged below the inductor plate and a lowered position effective for said inductive heating of a layer of grinding slurry located thereunder, and
d) a collecting system comprising openings in the carrier bowls and the conveyors, and collecting troughs are located in a lower region of the separating station for receiving grinding oil draining away from the layers of grinding slurry.

20. The separating station as claimed in claim 19, wherein the endless conveyor is formed as a belt conveyor with a linear conveying direction or as a circularly rotating conveyor.

21. The separating station as claimed in claim 19, further comprising a blasting head arranged downstream of the inductor plate in the conveying direction of the endless conveyor and connected to the lifting device for directing a stream of blasting air onto a carrier bowl after the carrier bowl has been conveyed away from the inductor plate and thereby driving out additional grinding oil from the layer of grinding slurry.

22. The separating station as claimed in claim 19, further comprising a preheating location upstream of the inductor plate in the conveying direction of the endless conveyor for preheating a layer of grinding slurry.

23. The separating station as claimed in claim 18 or 19, wherein the carrier bowl comprises a flat plate with the openings and an upwardly extending rim.

24. The separating station as claimed in claim 23, wherein the carrier bowl has a permeable intermediate base in the form of a screen or a perforated plate located spaced above the flat plate, the openings of the flat plate being larger than those of the intermediate base.

25. The separating station as claimed in claim 23, further comprising an abutting frame surrounding the rim, and supporting the abutting frame in an elastically yielding manner on the carrier bowl and, in the heating position of the carrier bowl, the abutting frame pressing against the inductor plate from below for holding together the flat layer of grinding slurry located on the carrier bowl.

26. The separating station as claimed in claim 25, further comprising a steel plate arranged for placement in the heating position of the carrier bowl, between the flat layer of grinding slurry and an underside of the inductor plate and resting directly on the layer of grinding slurry or on the abutting frame.

27. The separating station as claimed in claim 23, further comprising a steel plate, which is perforated or formed as a screen and arranged for being placed within the layer of grinding slurry in the carrier bowl.

28. The separating station as claimed in claim 23, wherein the flat plate consists of a ferromagnetic material.

29. A separating station, for separating grinding oil from a grinding slurry, comprising a belt conveyor movable continuously in a horizontal plane, in a path between a loading station for loading an endless layer of grinding oil slurry onto the belt conveyor and an unloading station for unloading grinding oil slurry form the belt conveyor, a constantly activated inductor plate arranged above the belt conveyor for heating the layer of grinding oil slurry passing therebelow on the belt conveyor, whereby an endless layer of grinding slurry located on the belt conveyor is heated region by region and portions of the grinding oil located in the endless layer of grinding slurry are made to drip off.

30. The separating station as claimed in claim 18, 19 or 29, wherein the inductor plate can be controlled for burning off amounts of the grinding oil remaining in the slurry after draining away of grinding oil from the slurry.

31. The separating station as claimed in claim 18, 19 or 29, further comprising an energy source downstream of the draining away of grinding oil for inductively heating remaining grinding oil sufficiently to burn remaining grinding oil.

32. A processing plant for separating grinding oil from a grinding slurry, comprising three treatment stations connected to one another the treatment stations comprising
a first treatment station, in which a mechanically acting separating device acts on a continuously flowing stream of the grinding slurry, and
a second treatment station, which is formed as a tank heated by heat exchangers, and which receives, temporarily stores and pre-heats the stream of grinding slurry flowing from the first treatment station, and
a third treatment station, which is formed as a separating station as claimed in claim 18, 19 or 29.

33. The processing plant as claimed in claim 32, wherein the mechanically acting separating device comprises a magnetic roller, a centrifuge or a sedimentation tank.

34. The processing plant as claimed in claim 32 further comprising a plant for re-cooling cooling lubricants of grinding machines, said plant for re-cooling being connected to said heat exchangers.

35. The processing plant as claimed in claim 32, further comprising a fourth treatment station comprising an energy source for burning off residual grinding oil from the grinding oil slurry.
